(19) United States
(12) Patent Application Publication
(10) Pub. No.: US 2010/0163176 A1
(43) Pub. Date: Jul. 1, 2010

(54) METHOD AND DEVICE FOR PRODUCING A FLOOR MADE OF END-GRAIN WOOD BLOCKS

(75) Inventors: Thierry Jooris, Bruxelles (BE); Francois Gaudard, Montrouge (FR)

Correspondence Address: YOUNG & THOMPSON, 209 Madison Street, Suite 500, Alexandria, VA, 22314, US

(73) Assignee: S.C. DES PAVES DU MOLIN NEUF, MONTBRON (FR)

(21) Appl. No.: 12/601,490

(22) PCT Filed: May 22, 2008
(86) PCT No.: PCT/FR2008/050890

§ 371 Date: Nov. 23, 2009

Related U.S. Application Data
(60) Provisional application No. 60/976,846, filed on Oct. 2, 2007.

(30) Foreign Application Priority Data
May 22, 2007 (FR) 07 55193

(51) Int. Cl. B27M 3/04; B27B 5/00; E04F 15/022; B32B 37/00

(52) U.S. Cl. 156/299; 156/512

(57) ABSTRACT

A process for the production of a slab that consists of cross-grained wood tie-beams includes the following stages: preparing cross-grained wood tie-beams (16); preparing a high-density substrate (12) to limit the compressibility; preparing an adhesive interface with a layer of a removable adhesive; and placing the tie-beams (16) on this interface. The device is also described.

This invention relates to a process and a device for the production of a slab that consists of tie-beams of cross-grained wood. This slab is designed to be juxtaposed with others for the purpose of producing a floor covering.

The cross-grained wood is obtained from pieces of wood cut crosswise relative to the fiber contrary to what is usually done for the cutting of a log. Actually, to take advantage of pieces of great length, the log is cut longitudinally, in the direction of the fiber.

A large part of forest production is not of value, namely the small-section trees, because it is impossible to remove from them pieces of wood of sufficient dimensions.

The owners of these plantations have two solutions, whereby the first is to wait for the tree to grow, which means in general several decades of waiting, and whereby the second is a low-value use of wood for heating or for the production of pulp.

In contrast, in such pieces of wood, it is entirely possible to produce tie-beams, i.e., pieces of cross-grained wood of several millimeters high and several centimeters on a side when the tie-beams are square or rectangular, to give an example.

European Patent EP 0,139,660, which describes a process for putting together a parquet floor from cross-grained wood blocks, is known.

This patent indicates a production of slabs with a superposition of a compressible foam substrate that forms a damping layer, a tear-proof weft, a layer of adhesive that wets the weft and makes it possible to attach the blocks of wood permanently to the wefted foam.

This makes it possible to address a problem of vertical expansion and allows vertical movement of the blocks relative to one another within the deformation limits of the damping layer.

So as to fill the spaces between the blocks of wood, a translucent paste is used.

This invention provides a different process because the problem is entirely different.

Thus, this invention takes into consideration that the cross-grained wood has high qualities of hardness and therefore resistance to wear and to abrasion and allows a large number of aesthetic effects. The cross-grained wood can be obtained from pieces of wood of small sizes, as indicated above.

In this way of cutting the wood crosswise relative to the grain, on the contrary it is deduced that the vertical expansion of a piece of cross-grained wood, if it indeed exists, is in contrast essentially the same from one piece of cross-grained wood to the next. This height variation, in addition to being extremely small, is not a problem since the pieces of cross-grained wood can expand freely in height. The problem has been a large degree of variation in expansion, unacceptable for obtaining a flat surface.

In addition, the vertical expansion is much smaller than the swelling or the horizontal contraction in area, and primarily the horizontal variations should be absorbed because the floor covering is constrained by the walls. It is necessary that the blocks of wood be able to move laterally over minimal distances, certainly, but these blocks cannot be made integral rigidly for fear of producing significant defects of surface evenness locally.

Another significant parameter to be taken into account is the drying of the wood from which the wood blocks are made.

The usual solution consists in starting from dried wood, which required storage in a stockyard and/or which has undergone a long run in a drying oven because the wood pieces generally have large dimensions, thus limiting the migration of water to the surface of the wood pieces.

Actually, the high cost hampers the distribution of this type of cross-grained wood product.

In the prior art, the wood blocks are spaced relative to one another, and it is necessary to fill in with a suitable filling material. Actually, whereby the blocks are made integral with the substrate, they cannot combine the expansions and transfer them to the periphery of the floor covering.

The process according to the invention makes it possible to produce slabs that consist of cross-grained wood tie-beams, designed to form a floor covering that eliminates the expansion problems in the horizontal direction, which can be produced industrially and which offers advantages during installation.

The associated device for the production of cross-grained wood tie-beams is also described.

The following description is drawn up with regard to the accompanying drawings that show:

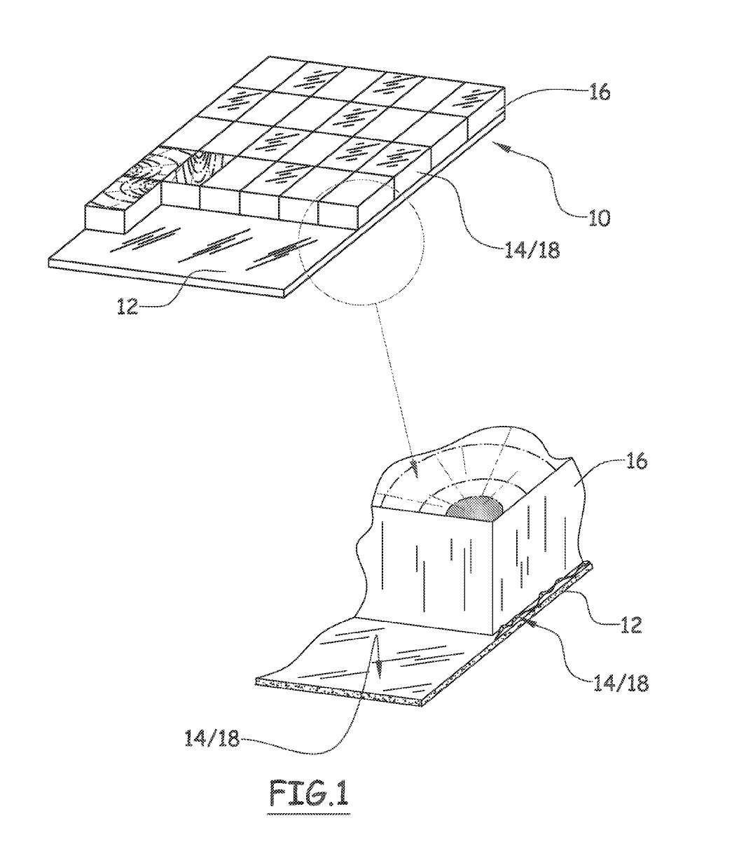

FIG. 1: A view of a slab that is made with cross-grained wood tie-beams according to the invention,

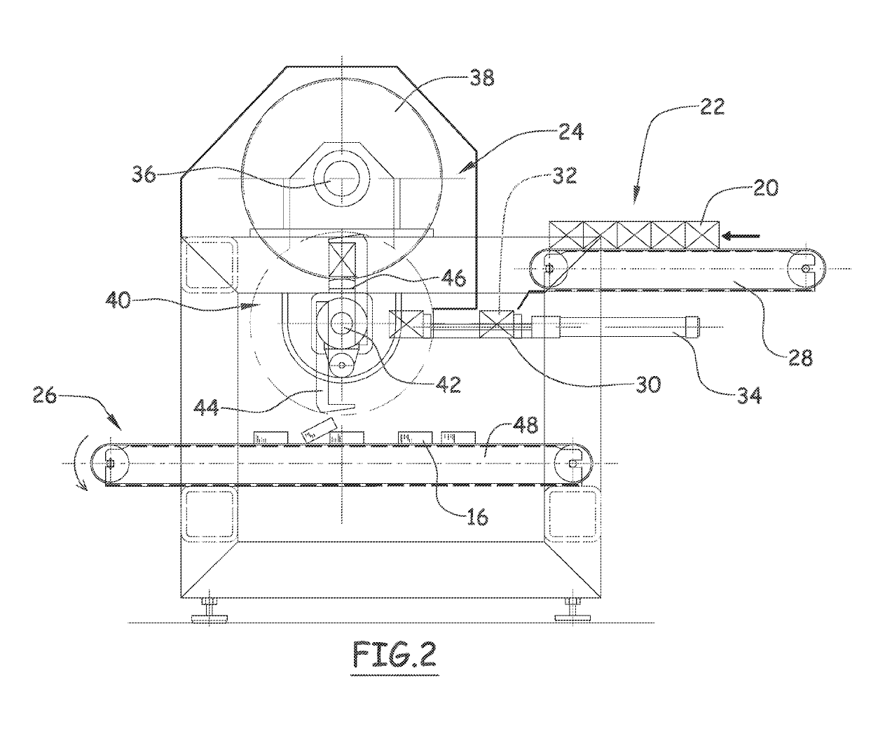

FIG. 2: A lateral elevation view of the device for preparation of the tie-beams, and

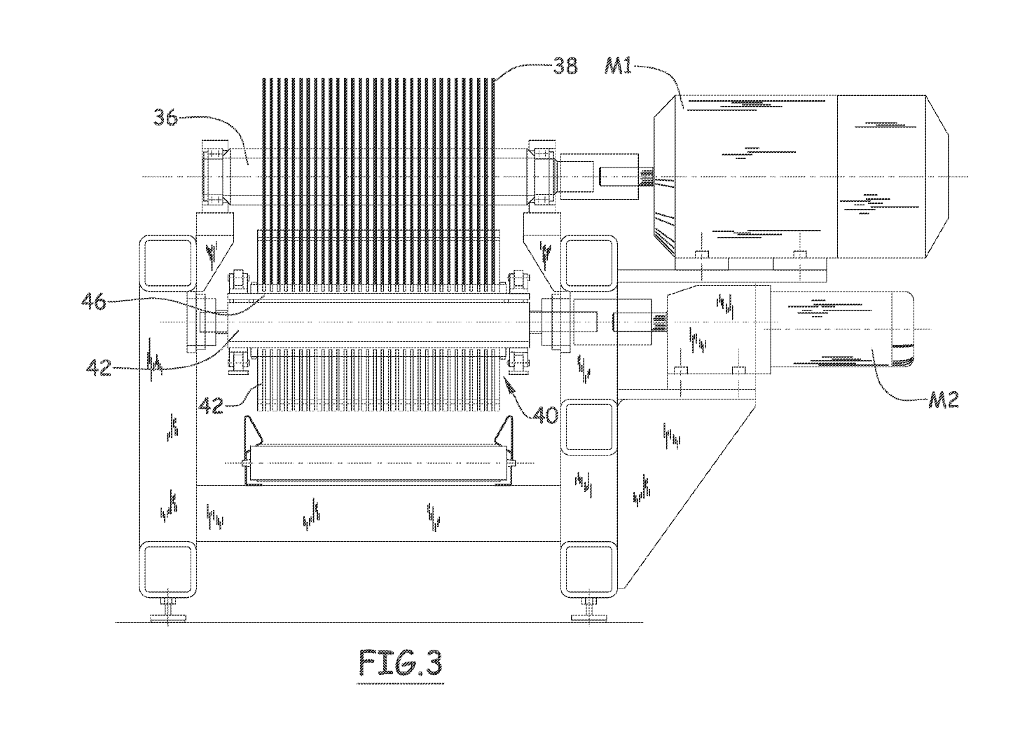

FIG. 3: A front view of the device of FIG. 2.

In FIG. 1, the slab 10 comprises a substrate 12, an adhesive interface 14 and cross-grained wood tie-beams 16 that are added to said interface.

The substrate 12 is advantageously a high-density foam to limit the compressibility, and therefore to limit the vertical movements. This foam has to preserve a flexibility, nevertheless, to facilitate the installation of slabs for the production of a complete floor covering.

The role of this foam is a sound-proofing insulation, but primarily this foam makes it possible to support, to maintain and to position the tie-beams.

The interface 14 comprises a layer of a removable adhesive 18. Such an adhesive adheres to the upper surface of the substrate 12 and accommodates the tie-beams 16. These tie-beams can be flattened on the adhesive and are made integral with said substrate, but they can be removed without damaging the adhesive and without making it lose its adhesive capacities, which is the particular feature of a removable adhesive.

Using this type of adhesive is important, because it also makes it possible to remove a tie-beam to allow its cutting, for example, in particular at the edge of the covering.

The tie-beams are placed perfectly juxtaposed without space designed to allow expansion and without space designed to accommodate mortar material.

The tie-beams expand and the horizontal expansion is transferred to the free edges of the floor covering, at the periphery.

In a known way, the piece that accommodates the floor covering comprises means for compensating the horizontal expansion on the periphery, of the compressible elastomer type, inserted between the wall and the covering.

One of the solutions also consists in implementing the process according to the invention that leads to obtaining tie-beams that have limited expansions that thus allow a juxtaposed installation.

The process consists in preparing wood blocks that have dimensions of 0.30 m to 1.5 m so that they are very straight. The section that is retained is square with 80 mm sides to provide a connection.

This block according to the process is cut by crosswise sawing.

The tie-beams that are obtained after sawing are then dried by any suitable means and in particular in an oven.

This particular stage of the process makes it possible to dry the tie-beams under satisfactory conditions.

Actually, the migration of the water is much faster, much more homogeneous, and is performed with limited gradients because of the reduced dimensions of the tie-beams.

In addition, the possible deformations are extremely limited because the length of the fibers is very short, since the length of the fibers corresponds to the thickness of the tie-beam. The release of the stresses is carried out without a problem.

Another important advantage relates to the quality of homogeneity of the tie-beams since they are all of the same dimensions, obtained from the same wood extract.

The adjustment of the drying parameters can be optimized since all of the tie-beams have purely the same dimensions.

In all of the cases, these deformations are perfectly compatible with the dimensional precision that is necessary for a floor covering, knowing that they can be eliminated during a final rubbing down after installation, if necessary.

When blocks are used that are cut in wood that has already been dried to the core, it is necessary to use wood that generally has undergone intensive drying, to a hygrometry level of 10%. For this to happen, very long drying periods are required. The period should be long to make the water migrate without producing too many varying stresses in the wood, but it should be short enough so that the operation is not too costly.

Because of this necessary compromise, because of the disparity of the dimensions of the wood pieces that are generally dried simultaneously, stresses in the wood are still present.

The blocks themselves of different lengths are cut from such wood pieces of different lengths.

However, it was noted that the stresses that the wood has undergone during drying are still present in the block and often are released after the tie-beams are cut, producing unacceptable deformations.

The fact of resorting to wood that is dried at the core is not the solution without counting the losses constituted by the sawdust and by the scraps that were from volumes of wood that were dried unnecessarily.

It is also known that there are defects in the wood, and certain tie-beams are unacceptable. These tie-beams that are rejected are also from the wood that is unnecessarily dried at the core as well as the tie-beams whose deformations are excessive.

The process according to the invention that consists in using the raw wood also advantageously makes it possible to dry only the strictly necessary volume of wood, without unnecessarily drying the volume of wood corresponding to the scraps during the cutting of the wood pieces for making blocks, to the sawdust of the tie-beams, to the scraps obtained from cutting the blocks, and to the tie-beams that are rejected as being not to spec.

The process according to the invention makes it possible to overcome a presumption and thus greatly reduces the costs of obtaining tie-beams in addition to improving the quality thereof at least regarding dimensional precision and the homogeneity of production.

Another solution consists in resorting to blocks that are cut into wood pieces of smaller dimensions, under dimensional multiples of a tie-beam. Thus, a tie-beam of 80 mm on a side comprises four pieces of 20 mm by 80 mm for the same height, necessarily. The cut pieces are dried, and then these pieces are assembled by gluing like the glued laminate.

These blocks are then very stable dimensionally, and the wood pieces have sections that are even smaller per unit, which also improves the drying and the release of stresses but modifies the final aesthetic aspect.

Then, the stresses of a quality cutting of the blocks are still present for implementing this process and for obtaining suitable tie-beams.

It is the object of the device that is now described with regard to FIGS. 2 and 3.

The blocks 20 with identical sections have different lengths based on the wood pieces from which they are obtained. These blocks are positioned at the input of the device.

The tie-beam-cutting device according to the invention comprises a supply station 22, a station 24 for sawing, and a removal station 26.

The supply station 22 comprises a conveyer 28 that supports the blocks 20.

This conveyor 28 supplies a positioning plate 30. This plate comprises a first wedging cylinder 32, perpendicular to the direction of supply to put the block in an abutting position by one of its ends, not visible in the figures.

The positioning plate 30 comprises a pressure cylinder 34 that continues the movement of the block 20 that is thus positioned abutting the sawing station 24. This plate is cut at its end to constitute a comb.

This sawing station 24 comprises a shaft 36, driven by a motor M1, bearing a succession of sharp-edged disks 38. The disks 38 are spaced by crosspieces, for example, so as to obtain between two successive disks a space that is equal to the thickness that is determined for the tie-beams, whereby this is done in a precision manner.

The thickness of the disks is reflected by the production of sawdust, as in any sawing operation. This thickness should be limited to reduce the losses, but sufficient to keep the disks rigid and to prevent vibrations under the sawing conditions provided.

Likewise, the profile of the set of teeth should be suitable to reach the best compromise between cutting speed, attacking the wood without fragments, end of cutting without fragments, limiting of overheating so as not to degrade the cutting surface since this surface is directly visible after the installation.

So as to obtain a very high cutting precision and to greatly limit the fragments, cutting guide means 40 are provided. These guide means 40 comprise a shaft 42 that bears at least one series of pins 44, driven in rotation by a motor M2.

The motor M2 is less powerful than the motor M1 since it presses only the blocks as explained, while M1 is to entrain numerous cutting disks whose speed has to remain almost constant both when empty and during the cutting.

Each pin end has a profile that is designed to work with that of a block. In this case, the profile is L-shaped. A stop 46, with a curved shape, for example a bar so as keep the block in the L-shaped profile during the cutting, is also provided.

The pins have a width and an arrangement such that they can pass between the disks. The pins are provided to bring each block to the cutting via the disks over its entire section.

Preferably, two series of pins installed at 180° are provided.

The two shafts 36 and 42 are aligned vertically.

In the lower portion of the device, means 26 for removal with a conveyor 48 designed to collected the tie-beams that thus have come from cutting are provided.

The device operates in the following way:

The blocks 20 are supplied by the conveyor 28. A translated block falls on the plate 30; this block is brought to a stop by the cylinder 32 then pushed toward the cutting station 24 by the cylinder 34.

The shaft 36 is continuously driven by the motor M1 at the suitable cutting speed.

When the block 20 is in place on the plate 30, the motor M2 in slow rotation moves a series of pins 44 that gather the block, raise it and move it through the disks 38 to obtain a cutting over the entire section.

The quality of this cutting is also improved by the fact that the block 20 follows a curvilinear path.

The thus cut tie-beams 16 fall on the conveyor 48.

These tie-beams 16 are thus ready to be dried.

These tie-beams, once dried, can be used to produce slabs 10.

1. Process for the production of a slab that consists of cross-grained wood tie-beams, characterized in that it comprises the following stages:
Preparing cross-grained wood tie-beams (16),
Preparing a high-density substrate (12) to limit the compressibility,
Preparing an adhesive interface (14) with a layer of a removable adhesive (18),
Placing the tie-beams (16) on this interface (14).

2. Process for the production of a slab according to claim 1, wherein the substrate (12) is a high-density foam to limit the compressibility and to limit the vertical movements.

3. Device for the production of tie-beams for the implementation of the process according to claim 1, wherein it comprises a station (22) for supply of blocks (20), a station (24) for multiple sawing, and a removal station (26).

4. Device for the production of tie-beams according to claim 3, wherein the supply station (22) comprises a conveyor (28) that supports the blocks so as to supply a positioning plate (30), a first wedging cylinder (32), perpendicular to the direction of supply to put the block in an abutting position by one of its ends, and a pressure cylinder (34) to move the block (20) that is thus positioned abutting the sawing station (24).

5. Device for the production of tie-beams according to claim 3, wherein the sawing station (24) comprises a shaft (36), driven by a motor M1, bearing a succession of sharp-edged disks (38), whereby these disks (38) are spaced so as to obtain between two successive disks a space that is equal to the thickness of a tie-beam.

6. Device for the production of tie-beams according to claim 3, wherein the cutting station (24) comprises cutting guide means (40).

7. Device for the production of tie-beams according to claim 6, wherein the cutting guide means (40) comprise a shaft (42) that bears at least one series of pins (44), driven in rotation by a motor M2 so as to press the blocks on the disks (38).

8. Device for the production of tie-beams according to claim 3, wherein the shafts (36) and (42) of the station (24) for sawing and guide means (40) are aligned.

9. Device for the production of tie-beams for the implementation of the process according to claim 2, wherein it comprises a station (22) for supply of blocks (20), a station (24) for multiple sawing, and a removal station (26).

10. Device for the production of tie-beams according to claim 4, wherein the sawing station (24) comprises a shaft (36), driven by a motor M1, bearing a succession of sharp-edged disks (38), whereby these disks (38) are spaced so as to obtain between two successive disks a space that is equal to the thickness of a tie-beam.

11. Device for the production of tie-beams according to claim 4, wherein the cutting station (24) comprises cutting guide means (40).

12. Device for the production of tie-beams according to claim 5, wherein the cutting station (24) comprises cutting guide means (40).

13. Device for the production of tie-beams according to claim 4, wherein the shafts (36) and (42) of the station (24) for sawing and guide means (40) are aligned.

14. Device for the production of tie-beams according to claim 5, wherein the shafts (36) and (42) of the station (24) for sawing and guide means (40) are aligned.

15. Device for the production of tie-beams according to claim 6, wherein the shafts (36) and (42) of the station (24) for sawing and guide means (40) are aligned.

16. Device for the production of tie-beams according to claim 7, wherein the shafts (36) and (42) of the station (24) for sawing and guide means (40) are aligned.
